(19) United States
(12) Patent Application Publication
(10) Pub. No.: US 2012/0278701 A1
(43) Pub. Date: Nov. 1, 2012

(54) Automatically Generating And Porting A Cascading Style Sheets ('CSS') Style Sheet

(75) Inventors: Michael A. Bockus, Oklahoma City, OK (US); Derek R. Brewer, Cleveland, OH (US); Jeffrey O. Manthei, Redwood Falls, MN (US); Robert D. Wilhelm, Cheyenne, WY (US)

(73) Assignee: INTERNATIONAL BUSINESS MACHINES CORPORATION, Armonk, NY (US)

(21) Appl. No.: 13/096,379

(22) Filed: Apr. 28, 2011

(51) Int. Cl. G06F 17/00

(52) U.S. Cl. 715/235

(57) ABSTRACT

Automatically generating and porting a cascading style sheets (‘CSS’) style sheet, including: identifying each node in a structured document; identifying, for each node in the structured document, presentation elements; creating the CSS style sheet; defining, in the CSS style sheet, presentation attributes for each presentation element; and porting the CSS style sheet to a rendering application for rendering the structured document.

### BACKGROUND OF THE INVENTION

1. Field of the Invention

The field of the invention is data processing, or, more specifically, methods, apparatus, and products for automatically generating and porting a cascading style sheets (‘CSS’) style sheet.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Modern computing systems often exchange information through the use of structured documents that are written in a markup language. Such structured documents may be used, for example, to deliver information to a user via a web browser. Such web browsers frequently include predetermined rules for rendering such structured documents. As such, the same structured document may be rendered in an inconsistent manner across multiple web browsers.

### SUMMARY OF THE INVENTION

Methods, apparatus, and products for method of automatically generating and porting a cascading style sheets (‘CSS’) style sheet, including: identifying each node in a structured document; identifying, for each node in the structured document, presentation elements; creating the CSS style sheet; defining, in the CSS style sheet, presentation attributes for each presentation element; and porting the CSS style sheet to a rendering application for rendering the structured document.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in automatically generating and porting a CSS according to embodiments of the present invention.

FIG. 2 sets forth a flow chart illustrating an example computer implemented method for automatically generating and porting a CSS style sheet according to embodiments of the present invention.

FIG. 3 sets forth a flow chart illustrating an example computer implemented method for automatically generating and porting a CSS style sheet according to embodiments of the present invention.

### DETAILED DESCRIPTION OF EXAMPLE EMBODIMENTS

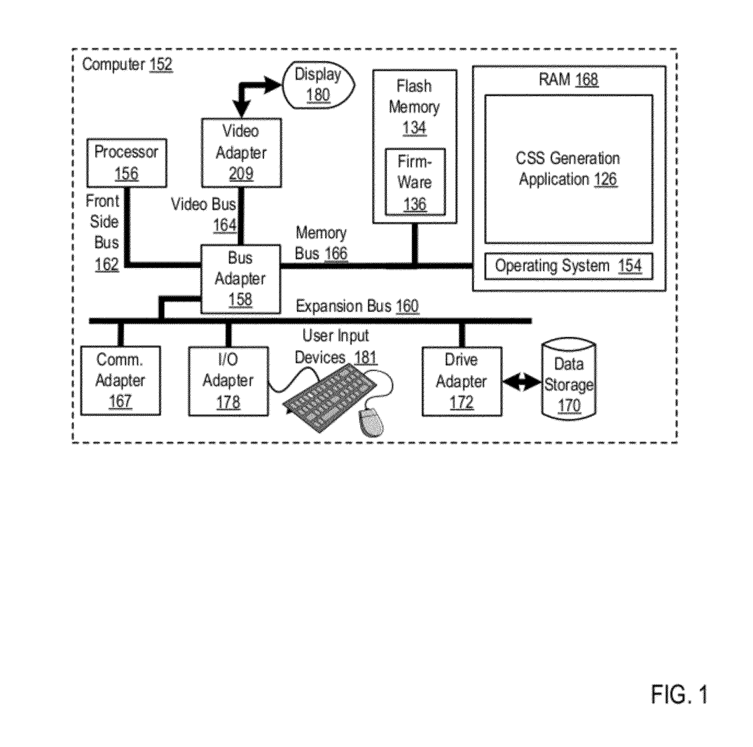

Example methods, apparatus, and products for automatically generating and porting a cascading style sheets (‘CSS’) style sheet in accordance with the present invention are described with reference to the accompanying drawings, beginning with FIG. 1.

Automatically generating and porting a CSS style sheet in accordance with the present invention is generally implemented with computers, that is, with automated computing machinery. FIG. 1 sets forth a block diagram of automated computing machinery comprising an example computer (152) useful in automatically generating and porting a CSS according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a CSS Generation Module (126), a module of computer program instructions improved for automatically generating and porting a CSS according to embodiments of the present invention. The CSS Generation Module (126) includes computer program instructions for identifying each node in a structured document. In the example of FIG. 1, a structured document is an electronic document where a scheme of embedded coding, such as markup, is used to give the entire document, and the parts contained therein, various structural meanings according to a schema. The structured document may be embodied, for example, as an HTML document, an XML document, and so on. In the example of FIG. 1, the structured document includes one or more nodes. Each node corresponds to a particular logical unit of the document. Each node may be embodied, for example, as a tag set consisting of a start tag and an end tag. Identifying each node in a structured document may therefore be carried out by inspecting the structured document for a start tag and a corresponding end tag.

The CSS Generation Module (126) also includes computer program instructions for identifying, for each node in the structured document, presentation elements. In the example of FIG. 1, presentation elements are node attributes that affect the presentation of node content. In the example of FIG. 1, identifying presentation elements for each node in the structured document may be carried out, for example by identifying a node type for each node in the structured document. The node type may be associated with standard attributes, such as an alignment attribute, a font color attribute, and the like that may be embedded within a particular tag to alter the presentation of content contained within a particular tag.

The CSS Generation Module (126) also includes computer program instructions for creating the CSS style sheet. In the example of FIG. 1, a CSS style sheet is a style sheet used to describe the presentation semantics of a document written in a markup language. The CSS style sheet may include presentation semantics that are used to apply presentation attributes to various nodes in the structured document.

The CSS Generation Module (126) also includes computer program instructions for defining, in the CSS style sheet, presentation attributes for each presentation element. In the example of FIG. 1, defining, in the CSS style sheet, presentation attributes for each presentation element in the structured document may be carried out, for example, by creating an entry in the CSS style sheet corresponding to each node identified in the structured document and specifying presentation values for each presentation element that is associated with each node in the structured document.

The CSS Generation Module (126) also includes computer program instructions for porting the CSS style sheet to a rendering application for rendering the structured document. In the example of FIG. 1, the rendering application may be embodied, for example, as a web browser or application capable of rendering a structured document. Porting the CSS style sheet to the rendering application may be carried out, for example, by storing the CSS style sheet in memory accessible to the rendering application and altering the settings of the rendering application to pass all structured documents through the CSS style sheet.

Also stored in RAM (168) is an operating system (154). Operating systems useful automatically generating and porting a CSS according to embodiments of the present invention include UNIX™, Linux™, Microsoft XP™, AIX™, IBM's i5/OS™, and others as will occur to those of skill in the art. The operating system (154) and CSS Generation Module (126) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for automatically generating and porting a CSS according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182) and for data communications with a data communications network. Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for automatically generating and porting a CSS according to embodiments of the present invention include modems for wired dial-up communications, Ethernet (IEEE 802.3) adapters for wired data communications network communications, and 802.11 adapters for wireless data communications network communications.

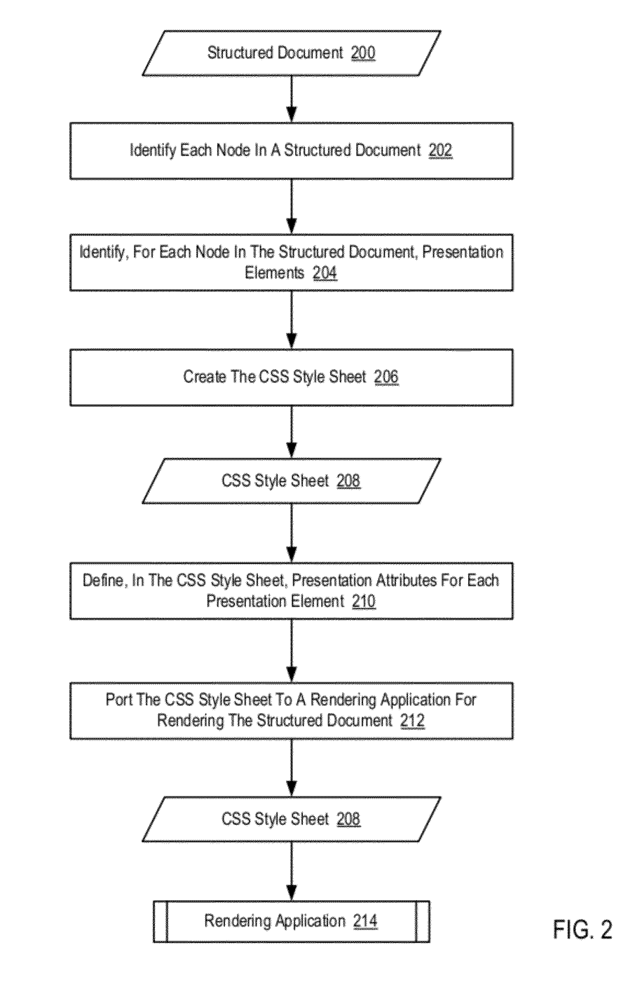

For further explanation, FIG. 2 sets forth a flow chart illustrating an example computer implemented method for automatically generating and porting a CSS style sheet (208) according to embodiments of the present invention that includes identifying (202) each node in a structured document (200). In the example of FIG. 2, a structured document is an electronic document where a scheme of embedded coding, such as markup, is used to give the entire document, and the parts contained therein, various structural meanings according to a schema. The structured document (200) of FIG. 2 may be embodied, for example, as an HTML document, an XML document, and so on.

In the example of FIG. 2, the structured document (200) includes one or more nodes. Each node corresponds to a particular logical unit of the document. Each node may be embodied, for example, as a tag set consisting of a start tag and an end tag. For example, consider the following structured document that is embodied as an HTML document:

```
<html>
    <head>
        <title> My Structured Document </title>
    </head>
    <body>
        <p> Hello World!</p>
    </body>
</html>
```

The example structured document illustrated above includes five nodes: the first node is defined by the <html> and </html> tags; the second node is defined by the <head> and </head> tags; the third node is defined by the <title> and </title> tags; the fourth node is defined by the <body> and </body> tags; and the fifth node is defined by the <p> and </p> tags. In the example of FIG. 2, identifying (202) each node in a structured document (200) may therefore be carried out by inspecting the structured document (200) for a start tag and a corresponding end tag.

The example of FIG. 2 also includes identifying (204), for each node in the structured document (200), presentation elements. In the example of FIG. 2, presentation elements are node attributes that affect the presentation of node content. For example, the example structured document illustrated above includes a node that is defined by the <p> and </p> tags. The <p> tag in HTML can support attributes such as an ‘align’ attribute that specifies the desired alignment of the content of the paragraph that is contained within the <p> and </p> tags, a ‘dir’ attribute that specifies the text direction for the content of the paragraph that is contained within the <p> and </p> tags, a ‘lang’ attribute that specifies the language for the content of the paragraph that is contained within the <p> and </p> tags, and so on.

In the example of FIG. 2, identifying (204) presentation elements for each node in the structured document (200) may be carried out, for example, by identifying a node type for each node in the structured document. The node type may be associated with standard attributes that may be embedded within the tag to alter the presentation of content contained within a particular tag. For example, a <p> tag in an HTML document has default presentation attributes such as a ‘dir’ attribute that specifies the text direction for the content of the paragraph that is contained within the <p> and </p> tags, a ‘lang’ attribute that specifies the language for the content of the paragraph that is contained within the <p> and </p> tags, and so on. As such, identifying that a node is a paragraph node means that presentation elements include a ‘dir’ presentation element and a ‘lang’ presentation element.

In an alternative embodiment, identifying (204) presentation elements for each node in the structured document (200) may be carried out, for example, through the use of a presentation element table. In the example of FIG. 2, a presentation element table includes a mapping of nodes to presentation elements that are associated with each node. Consider, for example, a structured document describing books in a library such as, for example, the following structured document:

```
<Book>
    <Author>Kurt Vonnegut</Author>
    <Title>Breakfast Of Champions</Title>
    <ISBN>0-385-28089-0</ISBN>
</Book>
<Book>
    <Author>John Kennedy Toole</Author>
    <Title>A Confederacy of Dunces</Title>
    <ISBN>0-8071-0657-7</ISBN>
</Book>
```

In the example of FIG. 2, the following presentation element table may be used to associate presentation elements with this structured document:

TABLE 1
Presentation Element Table

| Node Name | Presentation Element |
|---|---|
| Book | Background-Color |
| Book | Alignment |
| Book | Font |
| Author | Font |
| Author | Bold |
| Title | Font |
| Title | Italics |
| ISBN | Font |

The example presentation element table describes four types of nodes: a ‘book’ node, an ‘author’ node, a ‘title’ node, and an ‘ISBN’ node. The ‘book’ node has three presentation elements associated with it: a ‘background-color’ presentation element, an ‘alignment’ presentation element, and a ‘font’ presentation element. The ‘author’ node has two presentation elements associated with it: a ‘font’ presentation element and a ‘bold’ presentation element. The ‘title’ node has two presentation elements associated with it: a ‘font’ presentation element and an ‘italics’ presentation element. The ‘ISBN’ node has one presentation element associated with it: a ‘font’ presentation element.

The example of FIG. 2 also includes creating (206) the CSS style sheet (208). In the example of FIG. 2, the CSS style sheet (208) is a style sheet used to describe the presentation semantics of a document written in a markup language. In the example of FIG. 2, the CSS style sheet (208) is a style sheet used to describe the presentation semantics of the structured document (200). The CSS style sheet (208) may include presentation semantics that are used to apply presentation attributes to various nodes in the structured document.

The example of FIG. 2 also includes defining (210), in the CSS style sheet (208), presentation attributes for each presentation element in the structured document (200). In the example of FIG. 2, defining (210), in the CSS style sheet (208), presentation attributes for each presentation element in the structured document (200) may be carried out, for example, by creating an entry in the CSS style sheet (208) corresponding to each node identified in the structured document (200) and specifying presentation values for each presentation element that is associated with each node in the structured document (200). For example, the following example CSS style sheet may be created for the example structured document describing books in a library that is illustrated above:

```
Book {
      Background-Color = “White”;
      Alignment = “Centered”;
      Font = “Arial Narrow”;
}
Author {
      Font = “Arial Narrow”;
      Bold = “True”;
}
Title {
      Font = “Arial Narrow”;
      Italics = “True”;
}
ISBN {
      Font = “Times New Roman”;
}
```

The example CSS style sheet defines presentation attributes for each of the node types contained in the example structured document illustrated above. The example CSS style sheet specifies that for each node that is defined by the <Book> and </Book> tags, the content contained therein rendered upon a white background, with centered alignment, and in Arial Narrow font. The example CSS style sheet also specifies that for each node that is defined by the <Author> and </Author> tags, the content contained therein will be rendered in Arial Narrow font and in bold text. The example CSS style sheet also specifies that for each node that is defined by the <Title> and </Title> tags, the content contained therein will be rendered in Arial Narrow font and in italicized text. The example CSS style sheet specifies that for each node that is defined by the <ISBN> and </ISBN> tags, the content contained therein will be rendered in Times New Roman text.

The example of FIG. 2 also includes porting (212) the CSS style sheet (208) to a rendering application (214) for rendering the structured document (200). In the example of FIG. 2, the rendering application (214) may be embodied, for example, as a web browser or application capable of rendering a structured document. Porting (212) the CSS style sheet (208) to the rendering application (214) may be carried out, for example, by storing the CSS style sheet (208) in memory accessible to the rendering application (214) and altering the settings of the rendering application to pass all structured documents through the CSS style sheet (208).

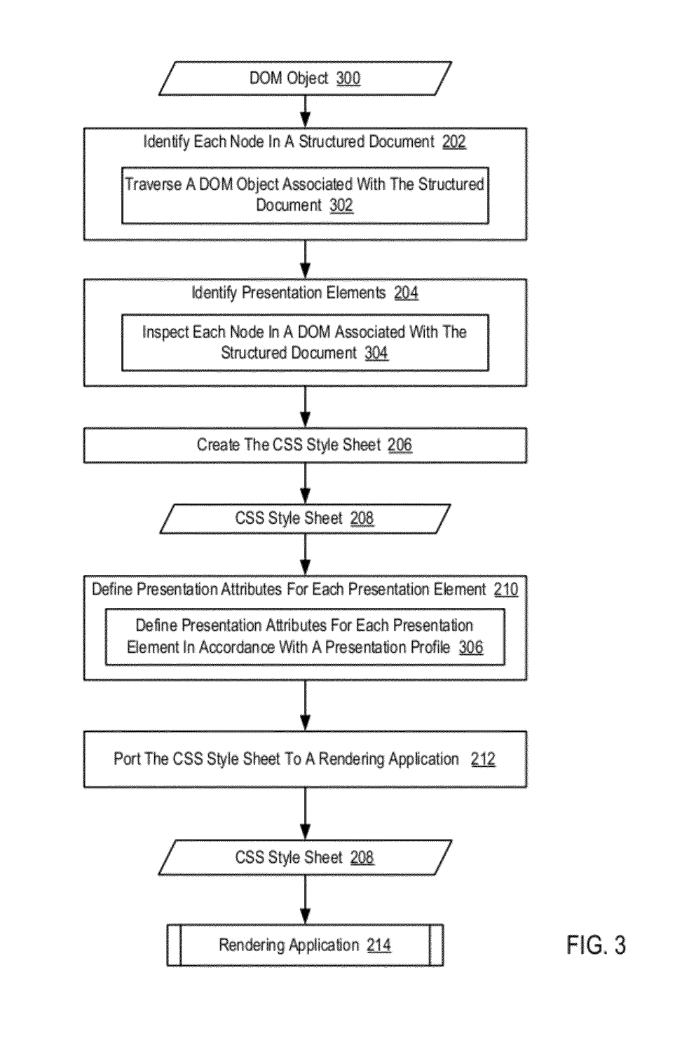

For further explanation, FIG. 3 sets forth a flow chart illustrating a further example method for automatically generating and porting a CSS style sheet (208) according to embodiments of the present invention. The example of FIG. 3 is similar to the example of FIG. 2 as it also includes identifying (202) each node in a structured document, identifying (204), for each node in the structured document, presentation elements; creating (206) the CSS style sheet (208); defining (210), in the CSS style sheet (208), presentation attributes for each presentation element; and porting (212) the CSS style sheet (208) to a rendering application for rendering the structured document.

In the example of FIG. 3, identifying (202) each node in a structured document includes traversing (302) a document object model (‘DOM’) (300) associated with the structured document. In the example of FIG. 3, a DOM is a cross-platform and language-independent convention for representing and interacting with objects in a structured document. A DOM object may be created, for example, by loading an XML document into a DOM object. In such an example, traversing (302) a DOM (300) associated with the structured document may be carried out by retrieving a node name for a particular node and recursively retrieving a node name for each child node of the particular node until the name of each node in the DOM object has been traversed.

In the example of FIG. 3, identifying (204), for each node in the structured document, presentation elements includes inspecting (304) each node in a DOM (300) that is associated with the structured document. In the example of FIG. 3, inspecting (304) each node in a DOM (300) may be carried out by traversing each node in a DOM object to determine if the node represents a presentation element. Since each element and attribute in a structured document is represented as a node in a DOM object, each node may be inspected to determine whether the node has a node name that is associated with presentation elements (e.g., a node name of ‘font-color’, ‘margin’, and so on). Likewise, each node may be inspected to determine whether the text associated with the node is associated with presentation elements. For example, a node in a DOM objects whose text is ‘red’ may be a node that defines some presentation element such as a font color, background color, and so on.

In the example of FIG. 3, defining (210), in the CSS style sheet (208), presentation attributes for each presentation element includes defining (306) presentation attributes for each presentation element in accordance with a presentation profile. In the example of FIG. 3, a presentation profile associates presentation elements with presentation values. For example, the presentation profile may associate a presentation element such as background color with a presentation value of yellow. In the example of FIG. 3, defining (306) presentation attributes for each presentation element in accordance with a presentation profile may be carried out, for example, by looking up each presentation element in the presentation profile and determining whether there is a corresponding presentation value in the presentation profile. If there is a presentation value for the presentation element in the presentation profile, the presentation attributes in the CSS style sheet may be defined such that each presentation element in the structured document will be rendered in accordance with the presentation profile.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer implemented method of automatically generating and porting a cascading style sheets (‘CSS’) style sheet, the method comprising:
identifying each node in a structured document;
identifying, for each node in the structured document, presentation elements;
creating the CSS style sheet;
defining, in the CSS style sheet, presentation attributes for each presentation element; and
porting the CSS style sheet to a rendering application for rendering the structured document.

2. The method of claim 1 wherein identifying each node in a structured document further comprises traversing a document object model (‘DOM’) associated with the structured document.

3. The method of claim 1 wherein identifying, for each node in the structured document, presentation elements further comprises inspecting each node in a DOM associated with the structured document.

4. The method of claim 1 wherein defining, in the CSS style sheet, presentation attributes for each presentation element include defining presentation attributes for each presentation element in accordance with a presentation profile.

5. The method of claim 1 wherein the rendering application is a web browser.

6. Apparatus for automatically generating and porting a cascading style sheets (‘CSS’) style sheet, the apparatus comprising a computer processor, a computer memory operatively coupled to the computer processor, the computer memory having disposed within it computer program instructions that, when executed by the computer processor, cause the apparatus to carry out the steps of:
identifying each node in a structured document;
identifying, for each node in the structured document, presentation elements;
creating the CSS style sheet;
defining, in the CSS style sheet, presentation attributes for each presentation element; and
porting the CSS style sheet to a rendering application for rendering the structured document.

7. The apparatus of claim 6 wherein identifying each node in a structured document further comprises traversing a document object model (‘DOM’) associated with the structured document.

8. The apparatus of claim 6 wherein identifying, for each node in the structured document, presentation elements further comprises inspecting each node in a DOM associated with the structured document.

9. The apparatus of claim 6 wherein defining, in the CSS style sheet, presentation attributes for each presentation element include defining presentation attributes for each presentation element in accordance with a presentation profile.

10. The apparatus of claim 6 wherein the rendering application is a web browser.

11. A computer program product for automatically generating and porting a cascading style sheets (‘CSS’) style sheet, the computer program product disposed upon a computer readable storage medium, the computer program product comprising computer program instructions that, when executed, cause a computer to carry out the steps of:
identifying each node in a structured document;
identifying, for each node in the structured document, presentation elements;
creating the CSS style sheet;
defining, in the CSS style sheet, presentation attributes for each presentation element; and
porting the CSS style sheet to a rendering application for rendering the structured document.

12. The computer program product of claim 11 wherein identifying each node in a structured document further comprises traversing a document object model (‘DOM’) associated with the structured document.

13. The computer program product of claim 11 wherein identifying, for each node in the structured document, presentation elements further comprises inspecting each node in a DOM associated with the structured document.

14. The computer program product of claim 11 wherein defining, in the CSS style sheet, presentation attributes for each presentation element include defining presentation attributes for each presentation element in accordance with a presentation profile.

15. The computer program product of claim 11 wherein the rendering application is a web browser.
